(19) United States
(12) Patent Application Publication
(10) Pub. No.: US 2013/0179356 A1
(43) Pub. Date: Jul. 11, 2013

(54) METHOD AND SYSTEM FOR MAINTENANCE OF TURBOMACHINERY

(71) Applicants: Joseph Vincent Pawlowski, Phoenix, AZ (US); Thomas Bradley Beddard, Marietta, GA (US); Birenda Kumar Nayak, Bangalore (IN); Christopher Dean Higgins, Greenville, SC (US); Krishnakumar Pallikkara Gopalan, Haryana (IN)

(72) Inventors: Joseph Vincent Pawlowski, Phoenix, AZ (US); Thomas Bradley Beddard, Marietta, GA (US); Birenda Kumar Nayak, Bangalore (IN); Christopher Dean Higgins, Greenville, SC (US); Krishnakumar Pallikkara Gopalan, Haryana (IN)

(73) Assignee: General Electric Company, Schenectady, NY (US)

(21) Appl. No.: 13/344,576

(22) Filed: Jan. 5, 2012

(51) Int. Cl. G06Q 10/00

(52) U.S. Cl. 705/305

(57) ABSTRACT

A method and a system for analysis of turbomachinery are provided. In one embodiment, a system includes a request initiation system configured to initiate a departure request for a turbomachinery. The system further includes a commercial screening system configured to receive the departure request and to derive a commercial evaluation based on the departure request. The system also includes a technical evaluation system configured to derive a technical evaluation profile based on the departure request. The system additionally includes a request acceptance system configured to derive at maintenance action based on the commercial evaluation and the technical evaluation profile, wherein the technical evaluation profile comprises a technical analysis of the turbomachinery.

### BACKGROUND OF THE INVENTION

The invention relates generally to turbomachinery, and more particularly to a method and system for the maintenance of turbomachinery.

Turbomachinery may include an apparatus such as a turbine, a compressor, or a pump. As the turbomachinery operates, efficiency and performance may change over time. This change in performance may be due to various factors such as wear or component damage. Maintenance, including replacement of certain turbomachinery components, may be applied to the turbomachinery to restore efficiency and operational performance. However, the maintenance may be applied inefficiently, and may be costly.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In one embodiment, a system includes a request initiation system configured to initiate a departure request for a turbomachinery. The system further includes a commercial screening system configured to receive the departure request and to derive a commercial evaluation based on the departure request. The system also includes a technical evaluation system configured to derive a technical evaluation profile based on the departure request, wherein the technical evaluation profile comprises a technical analysis of the turbomachinery. The system additionally includes a request acceptance system configured to derive at maintenance action based on the commercial evaluation profile and the technical evaluation profile.

In a second embodiment, a method includes initiating a maintenance change request for a turbomachinery. The method also includes performing a commercial screening based on the maintenance change request, and performing a technical screening if the commercial screening determines that the maintenance change request is commercially feasible. The method further includes performing a technical risk assessment if the technical screening determines that the maintenance change request is technically feasible. The method additionally includes providing a technical recommendation, deriving a maintenance action based on the technical recommendation, and executing the maintenance action if the technical risk assessment determines that a risk of the maintenance change request is acceptable.

In a third embodiment, a non-transitory machine readable media comprises instructions configured to initiate a maintenance change request relating to turbomachinery. The instructions are further configured to commercially screen the maintenance change request to produce a commercial report. The instructions are additionally configured to technically analyze the maintenance change request to produce a technical report, and to accept the commercial report and the technical report to produce a maintenance action.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a turbmoachinery, e.g., turbine system, including a sensor database;

FIG. 2 is a flow chart of a process useful in extending operations for the turbomachinery of FIG. 1;

FIG. 3 is a block diagram of an embodiment of a system suitable for implementing the process of FIG. 2; and

FIG. 4 is a timeline diagram of an embodiment of a usage and maintenance schedule for the turbomachinery of FIG. 1.

### DETAILED DESCRIPTION OF THE INVENTION

One or more specific embodiments of the invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the invention, the articles “a,” “an,” “the,” and “said” are intended to mean that there are one or more of the elements. The terms “comprising,” “including,” and “having” are intended to be inclusive and mean that there may be additional elements other than the listed elements.

Turbomachinery, such as a gas turbine, a steam turbine, a compressor, or a pump, may undergo changes or shifts in performance during operation. For example, the turbine engine may shift from operating at certain revolutions per minute (RPM) to operating at a lower or higher RPM without any changes made by an operator or controller for the turbine engine. The operational changes (e.g., changes in RPM, temperature, pressure, vibration) of the turbomachinery may be attributed to certain conditions, such as worn components and/or unexpected maintenance events (e.g., blade cracks, shroud cracks, rubbing of moving and stationary parts, or leakage). Accordingly, maintenance operations may be scheduled to occur at specific time periods (e.g., 1 month, 6 months, 2 years), such as the replacement and inspection of certain of the turbomachinery components.

In one embodiment, a contractual agreement between a service provider and a turbomachinery operator (e.g., turbomachinery owner or lessee) may specify the maintenance schedule and type of maintenance to be performed. For example, a hot gas path inspection (HGPI) may be contractually specified to occur approximately every 24,000 fired hours or at any other desired time period (e.g., every 2 years). In another embodiment, no contractual agreement may be used. In this embodiment, the maintenance may also occur cyclically or when otherwise specified by the turbomachinery operator. During turbomachinery operations, it may be beneficial to postpone or, more generally, to extend the scheduled maintenance. For example, a power plant may postpone maintenance on a gas turbine in order to provide added power during an unexpected event (e.g., offlining of a sister power plant). Once the postponed maintenance occurs, certain components may be replaced or sent for repair, even though the components may still be in good serviceable condition. Additionally, an “execution factor” may be assessed, that incurs a debit from the service provider. That is, the service provider may be asked to incur a cost due to, for example, the replacement and/or repairs incurred and/or the postponement of the maintenance.

In one embodiment, the systems and methods described herein apply condition based maintenance (CBM) techniques, including condition based maintenance outage (CBM-O) techniques and condition based maintenance interval (CBM-I) techniques to extend the scheduled maintenance. The system and methods described herein may enable the postponement of maintenance while minimizing or eliminating “execution factor” debits. The replacement and/or repair submissions of turbomachinery parts may also be minimized or eliminated, thus resulting in a more efficient utilization of plant resources and maintenance operations.

Commercial models, including cost benefit analysis models, economic models, or a combination thereof, may be used to provide for commercial analysis of current and future impact associated with changes in maintenance of the turbomachinery. Engineering models, including statistical analysis models, visual inspection models, physics-based models, or a combination thereof, may be used to provide for engineering analysis of the performance and operational state of the turbomachinery and the turbomachinery components. Risk assessment models may also be used, including probabilistic risk assessment models, risk management models, or a combination thereof, suitable for enabling an approximate derivation of risk associated with postponing the scheduled maintenance and returning certain turbomachinery components into operation as-is. By analyzing the impact of the delay in maintenance operations, and by providing for an approximate measure of risk associated with using as-is components, the systems and methods described herein enable a more efficient utilization of turbomachinery, provide for lower costs, and increase the flexibility in maintenance scheduling.

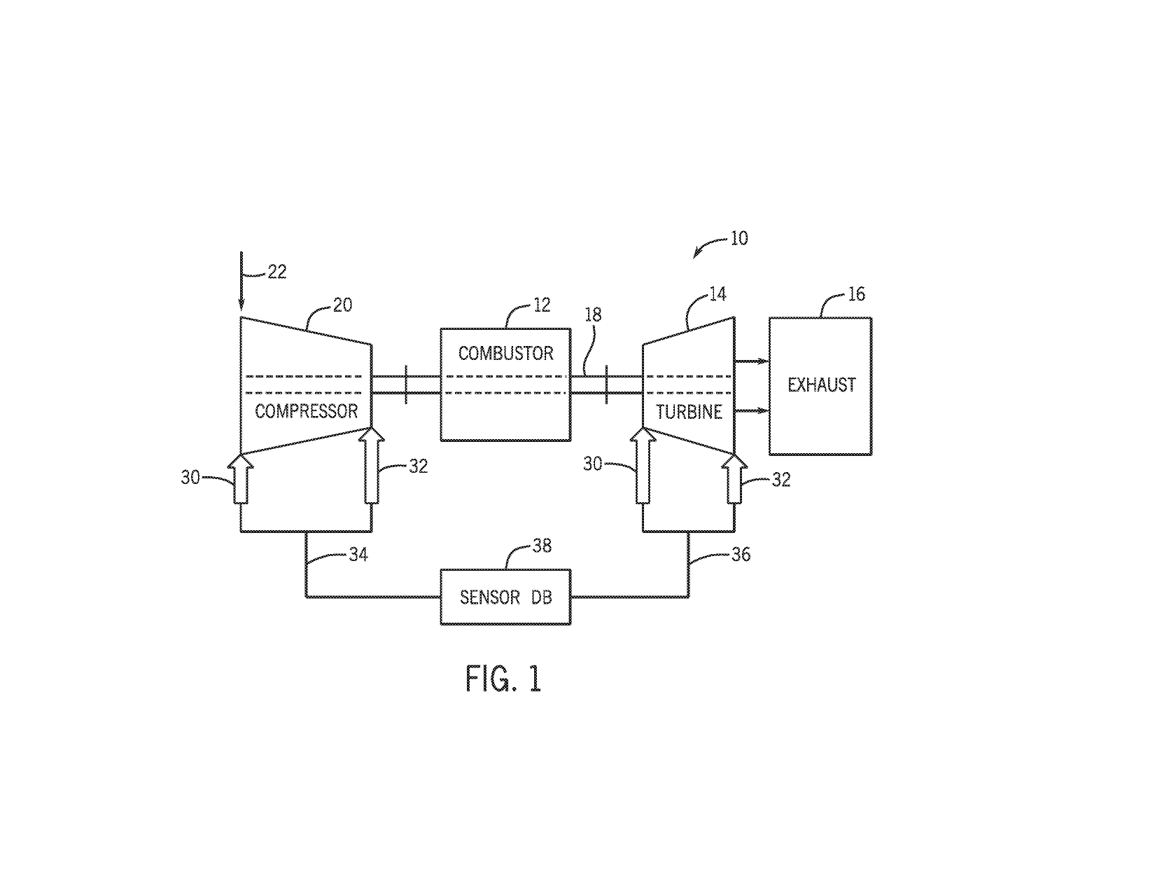

With the foregoing in mind, it may be useful to describe an embodiment of a turbomachinery incorporating techniques disclosed herein, such as a gas turbine system 10 illustrated in FIG. 1. As depicted, the turbine system 10 may include a combustor 12. The combustor 12 may receive fuel that has been mixed with air, for combustion in a chamber within combustor 12. This combustion creates hot pressurized exhaust gases. The combustor 12 directs the exhaust gases through a turbine 14 toward an exhaust outlet 16. The turbine 14 may be part of a rotor. As the exhaust gases pass through the turbine 14, the gases force turbine blades to rotate a drive shaft 18 along an axis of the turbine system 10. As illustrated, the drive shaft 18 is connected to various components of the turbine system 10, including a compressor 20.

The drive shaft 18 may include one or more shafts that may be, for example, concentrically aligned. The drive shaft 18 may include a shaft connecting the turbine 14 to the compressor 20 to form a rotor. The compressor 20 may include blades coupled to the drive shaft 18. Thus, rotation of turbine blades in the turbine 14 causes the shaft connecting the turbine 14 to the compressor 20 to rotate blades within the compressor 20. This compresses air in the compressor 20. The rotation of blades in the compressor 20 compresses incoming air 22. The compressed air is fed to the combustor 12 and mixed with fuel to allow for higher efficiency combustion. The shaft 18 may also be connected to a load, which may be a vehicle or a stationary load, such as an electrical generator in a power plant or a propeller on an aircraft.

The turbine system 10 may also include a plurality of sensors, configured to monitor a plurality of engine parameters related to the operation and performance of the turbine system 10. The sensors may include, for example, inlet sensors 30 and outlet sensors 32 positioned adjacent to, for example, the inlet and outlet portions of the turbine 14, and the compressor 20, respectively. The inlet sensors 30 and outlet sensors 32 may measure, for example, environmental conditions, such as ambient temperature and ambient pressure, as well as a plurality of engine parameters related to the operation and performance of the turbine system 10, such as, exhaust gas temperature, rotor speed, engine temperature, engine pressure, gas temperature, engine fuel flow, exhaust flow, vibration, noise, clearance between rotating and stationary components, compressor discharge pressure, combustion dynamics, pollution (e.g., nitrogen oxide [NOx] emissions, sulfur oxide [SOx] emissions, carbon oxides [COx], and particulate count), and turbine exhaust pressure. Further, the sensors 30 and 32 may also measure actuator information such as valve position, and a geometry position of variable geometry components (e.g., air inlet).

The plurality of sensors 30 and 32 may also be configured to monitor engine parameters related to various operational phases (e.g., start-up, shut-down, or steady state of operation) of the turbine system 10. Measurements taken by the plurality of sensors 30 and 32 may be transmitted via module lines 34 and 36, which may be communicatively coupled to a sensor database (DB) 38. For example, module line 34 may be utilized to transmit measurements from the compressor 20, while module line 36 may be utilized to transmit measurements from the turbine 14. It is to be understood that other sensors may be used, including combustor 12 sensors, exhaust 16 sensors, intake 22 sensors, and load 24 sensors. It is also to be understood that the gas turbine system 10 is only an example embodiment of turbomachinery, and that other gas turbine systems may include, for example, multiple turbines, multiple shafts, and other arrangement of system 10 components. Alternatively, the turbomachinery may not be a gas turbine system 10 but may be a steam turbine, a hydroturbine, or a wind turbine.

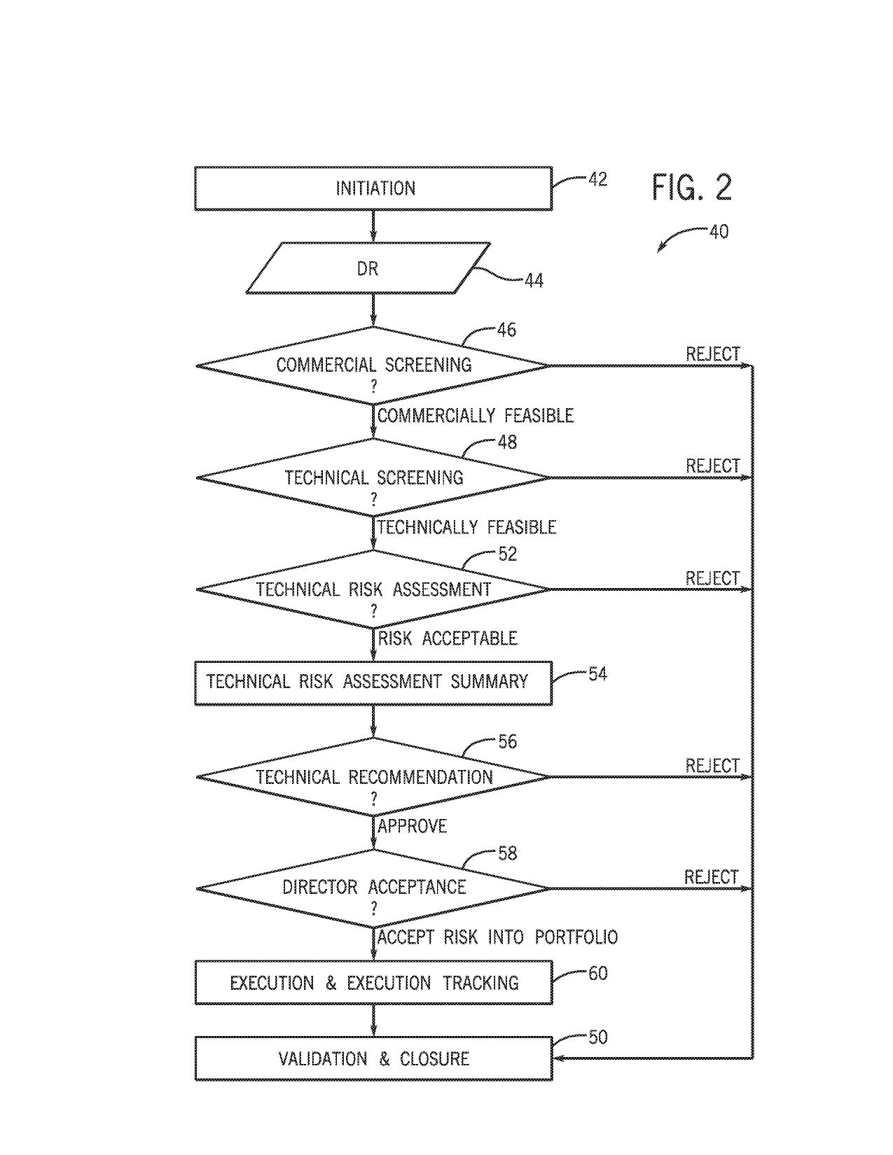

As mentioned above, the gas turbine system 10 may experience performance changes attributed to worn components and/or unexpected events (e.g., blade cracks, compressor 12 misfiring, turbine 14 fouling, unbalanced shaft 18 or, fluid leakage). Accordingly, a scheduled maintenance interval may be provided, suitable for maintaining the operational performance and extending the life of the turbine system 10 and related components. However, it may be useful to postpone or otherwise extend certain scheduled maintenance activities. For example, a business climate may be conducive to continued operations due to higher energy demand and prices. Likewise, weather events may occur to create an environment where a sister power plant is rendered inoperable. Thus, it may be desirable to exceed certain maintenance schedules and/or operational limits to increase profitability and meet customer needs. For example, it may be desirable to operate the turbine system 10 for a longer interval, at longer fired hours, and/or with an increased number of starts (e.g., cold starts, hot starts) than recommended by the turbine system 10 manufacturer. Advantageously, a process, such as the process described in more detail below with respect to FIG. 2, enables the turbine system 10 to exceed maintenance schedules and operational limits, while maintaining operational reliability and performance.

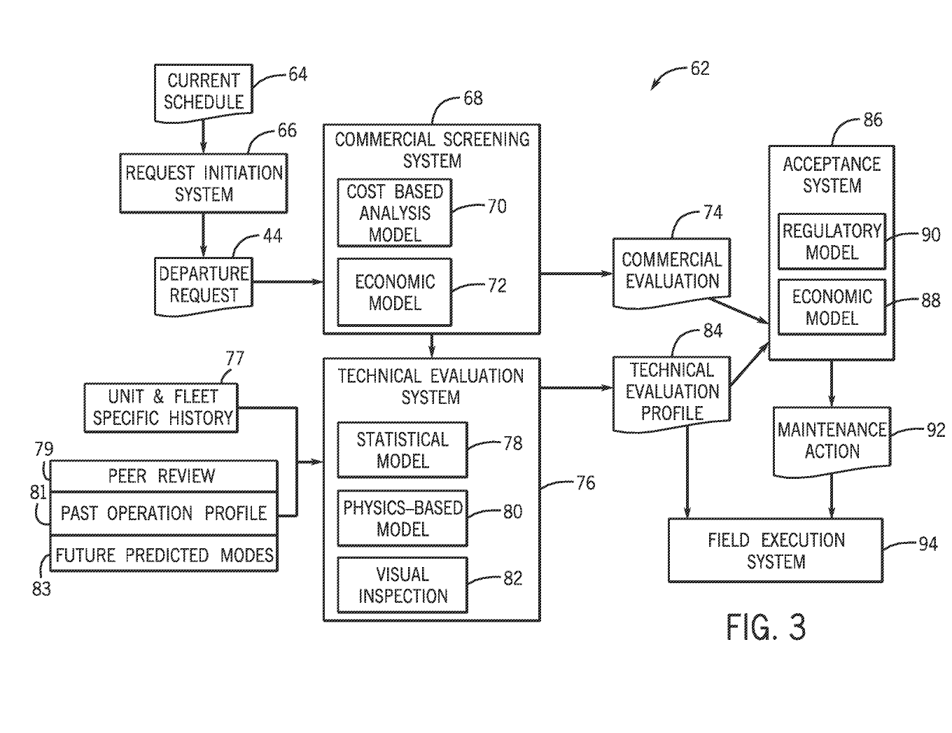

FIG. 2 is flow chart of an embodiment of a process 40 suitable for analyzing the effects of exceeding maintenance schedules and/or operational limits of turbomachinery, such as the turbine system 10 of FIG. 1. Further, the process 40 may provide for more efficient utilization of the turbomachinery 10 by enabling the continued use of turbomachinery 10 components that may have otherwise been replaced, or removed and sent to a repair facility for repair work. Additionally, the process 40 may enable the continued operation of the turbomachinery 10 in a reliable manner, even though the continued operation may exceed manufacturer recommendations for fired hours, number of starts, and other operational measures including operating temperatures, pressures, flow rates, and/or clearances (e.g., distance between a rotating component and a fixed component). The process 40 may be implemented as executable code instructions stored on a non-transitory tangible computer-readable medium, such as the volatile or non-volatile memory of a computer or a computer system, such as the system described in FIG. 3.

In the depicted embodiment, the process 40 may be initiated (block 42), for example, by initiating a maintenance change request. In one embodiment, the maintenance change request may be a departure record or request 44 (e.g., service delay request) describing a departure from a scheduled maintenance activity, such as a hot gas path inspection (HGPI), a combustion inspection (CI), a major inspection (MI), or any other scheduled maintenance activity. In this embodiment, a liaison personnel interfacing between the owner/lessee of the turbomachinery 10, such as a contract performance manager (CPM), may initiate the departure record 44. The departure record 44 may include the type of maintenance to be postponed (e.g., HGPI, CI, MI), the desired postponement interval (e.g., days, hours, weeks, months), departure limits (e.g., additional fired hours, additional number of startups, additional fuel usage, additional power production, desired temperatures, desired pressures, desired flow rates, desired clearances), the current status of the turbomachinery 10 (e.g., operational status), the maintenance records for the turbomachinery 10, reason(s) for postponement, and so forth. The departure record 44 may then be commercially screened (decision 46).

During commercial screening, a business analysis of the impact or effects of the rescheduling of maintenance may be performed, for example, by a customer value performance manager (CVPM) or operations manager. The commercial screening (decision 46) may including using business models, such as a cost based analysis, an economic analysis, or a combination thereof, to derive the effects of the departure record. The cost based analysis may look at the cost impact of the departure record. For example, logistic costs associated with rescheduling supplier deliveries, parts procurement, inventory management, and the like, may be taken into consideration. Likewise, personnel cost associated with rescheduling activities, personnel availability, and certification requirements, may be calculated. Other costs may be derived, including fuel supply costs, licensing costs (e.g., remaining in compliance with state and federal regulations), emissions costs of continued operations, and capital costs (e.g., capital depreciation due to additional usage).

The economic analysis may include a return on investment (ROI) analysis suitable for comparing the returns associated with the derived costs of the departure. For example, benefits accrued by continued operations, including profits of the sale of power, increases in the price of power, increases in the demand for power, capturing competitor markets, goodwill, and the like, may be used to derive a ROI associated with the departure request 44. By providing for a commercial assessment of the departure request 44 the process 40 may enable a comprehensive business impact of the request 44 effects. If the departure request 44 is deemed commercially feasible, then a technical screening (decision 48) may occur. Otherwise, a validation and closure process (block 50) may close out the departure record 44 and notify the CPM and owner/lessee of the reasoning behind the closure.

The technical screening (decision 48) may involve an engineering team inspecting the turbomachinery 10 to insure a reliable operation during the departure. For example, various components of the turbomachinery 10, such as the combustor 12, the turbine 14, the exhaust system 16, the compressor 20, the load 24, among others, may be technically screened (decision 48) to ensure that the turbomachinery 10 is suitable for continued operations. Likewise, a configuration check of the turbomachinery 10 may be performed during the technical screening (decision 48) useful in determining the suitability of the particular configuration or arrangement of the components of the turbomachinery 10 for continuing operations. By providing for a technical screening (decision 48), the process 40 may enable more reliable and safe operations of the turbomachinery 10. If the technical screening (decision 48) finds that the turbomachinery may not participate in the departure, then the validation and closure process (block 50) may close the departure request 44 and inform the interested parties (e.g., the CPM and owner/lessee) of the reasoning behind the closure. Otherwise, the technical screening (decision 48) may approve the technical feasibility of continued operations.

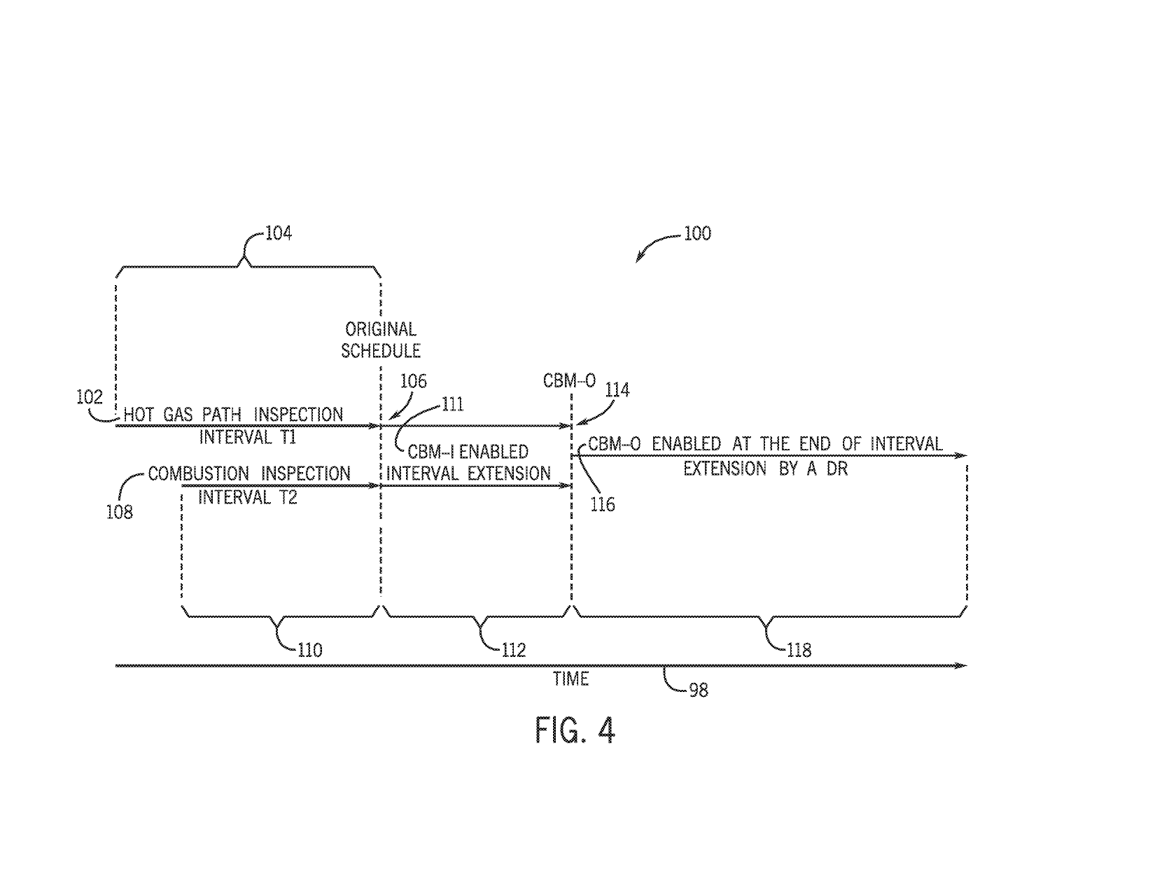

The process 40 may then perform a technical risk assessment or analysis (decision 52). Advantageously, the technical risk assessment (decision 52) may include deriving a risk of operating the turbomachinery 10 beyond certain ranges to ensure the reliability of the operations. For example, the turbomachinery 10 components may be reliably operated by applying a CBM-O analysis or workflow after applying a CBM-I analysis or workflow. That is, the CBM-I and the CBM-O may include certain engineering analyses or workflows, as described in more detail below with respect to FIG. 4, that provide for a determination of which turbomachinery 10 components may still perform as desired and need not be replaced or sent for repair after completion of their extended use period. By providing for a mechanism to maximize the usage of the turbomachinery 10 components, the turbomachinery's 10 life cycle usage may be optimized and costs incurred by unnecessary replacements and/or repairs may be minimized or eliminated. Additionally, the “execution factor” cost associated with the replacements and/or repairs may be correspondingly reduced or eliminated.

The process 40 may then produce a technical risk assessment summary 54 useful in describing the technical risk assessment (decision 52) activities and in providing for a written record of the analyses performed, the results, and the risks associated with the departure request 44. If the technical risk assessment (decision 52) derives an unacceptable risk of extending operations of the turbomachinery 10, then the validation and closure process (block 50) may close the departure request 44 and inform the interested parties (e.g., the CPM and owner/lessee) of the reasoning behind the closure. Otherwise, the technical risk assessment (decision 52) may approve the technical risk of continued operations.

The process 40 may then provide for a technical recommendation (decision 56) detailing a recommended course of action for the turbomachinery 10. For example, the technical recommendation (decision 56) may include a list of extended operational recommendations (e.g., operating up to a recommended number of fired hours, operating up to a recommended number of cold starts, operating up to a recommended temperature, operating up to a recommended pressure, using a recommended fuel type, operating at a recommended flow rate). If the technical recommendation (decision 56) rejects extended operations for the turbomachinery 10, then the validation and closure process (block 50) may close the departure request 44 and inform the interested parties (e.g., the CPM and owner/lessee) of the reasoning behind the rejection of the recommendation. Otherwise, the process 40 may then enable a high level manager or director to accept (decision 58) the newly extended turbomachinery 10 operations.

In one embodiment, the director acceptance (decision 58) may include a higher level (e.g., director level) manager evaluating all of the aforementioned decisions 46, 48, 52, and 56) to provide for an added oversight over the process 40. Additionally, the director acceptance (decision 58) may include analyzing current and/or future regulations, including state and federal regulations related to turbomachinery 10 operations (e.g., occupational safety and health administration (OSHA) regulations, particulate emissions regulations, chemical emissions regulations). Should the director acceptance (decision 58) reject the proposed deviation from maintenance activities, then the validation and closure process (block 50) may close the departure record 44 and inform the interested parties (e.g., the CPM and owner/lessee) of the reasoning behind the director's rejection. If the proposed deviation of turbomachinery 10 operations is accepted, then the process 40 may execute and track (block 60) the proposed deviations.

The execution and execution tracking (block 60) may include performing any recommendation output from the technical recommendation activities (decision 56). The execution and execution tracking (block 60) may further include tracking or otherwise logging the activities and performance of the turbomachinery 10 during the extended turbomachinery 10 operations. For example, the sensor DB 38 depicted in FIG. 1 may be used to store data during the execution activities. Likewise, electronic logs, paper logs, and other records may be kept of the extension of turbomachinery 10 operations and performance. For example, the records kept during the execution and execution tracking (block 60) may be analyzed to ensure that the turbomachinery 10 is within desired operational parameters (e.g., number of fired hours, number of starts, temperatures, pressures, flow rates, clearances). In this manner, technical recommendations may be executed and the execution may be tracked or monitored (block 60). The process 40 may then validate and close (block 50) the extended turbomachinery 10 operations. By providing for a process 40 useful in extending the operations of the turbomachinery 10, the turbomachinery 10 may be more optimally used with increased cost savings.

FIG. 3 is a block diagram of an embodiment of a system 62 that may be used to implement or execute the process 40 depicted in FIG. 2. In the depicted embodiment, a current schedule 64 may be input into a request initiation system 66. The current schedule 64 may include planned maintenance activities for the turbomachinery 10 depicted in FIG. 1, such as HGI, CI, and/or MI activities. As mentioned above, it may be desirable to extend certain operations of the turbomachinery 10. Accordingly, the departure request 44 may be prepared by the request initiation system, detailing desired schedule extensions (e.g., maintenance postponements), and/or operational extensions (e.g., additional fired hours, number of starts, temperatures, pressures, flow rates, clearances). For example, a user (e.g., contractual services user, transactional services user) may enter desired schedule extension information and operational extension information into the request initiation system 66 to produce the departure request 44.

The departure request 44 may then be commercially screened by using a commercial screening system 68. The commercial screening system 68 may include, for example, a cost based analysis model 70 and an economic model 72. As mentioned above with respect to FIG. 2, a cost based analysis and an economic analysis may be used to determine the commercial feasibility of the departure request 44. Accordingly, the cost based analysis model 70 and the economic model 72 may be used for the cost based analysis and the economic analysis, respectively. In one embodiment, the models 70 and 72 may include electronic and/or paper spreadsheets with cost based calculations, economic calculations, and the like, suitable for deriving an ROI comparing the returns or profits of extending operations of the turbomachinery 10 with the derived costs. In this manner, a commercial evaluation report 74 may be prepared by the commercial screening system 68, detailing the cost based analysis and economic analysis.

Additionally, a technical evaluation system 76 may be used to enable the technical analysis of the turbomachinery 10. In the depicted embodiment, the technical evaluation system 76 includes a statistical model 78, a physics-based model 80, and a visual inspection system 82. Inputs based on a unit and fleet specific history 77, a peer review 79, a past operation profile 81, and/or a future predicted modes 83 may also be used. Peer review 79 may include review with experts and/or representatives from design teams, repair teams, product services teams, condition based maintenance teams, and/or reliability teams. The peer review 79 may incorporate a “second look” during technical evaluations. The past operation profile 81 may include data related to past operations, including turbine system operating profiles or graphs for cold starts, warm starts, trips, shutdowns, and the like. The future predicted modes 83 may include operational modes intended, for example, for use in the turbine 14 in the future. For example, it may be desired to operate the turbine 14 using a start based operational mode, a fired hours operational mode, or a combination thereof. The statistical model 78 may include sub-models such as linear regression models, non-linear regression models, data mining models, or a combination thereof, that may be used to predict future turbomachinery 10 conditions, based on past observations (e.g., unit and fleet specific history 77, pas operation profile 81). For example, blade cracks, combustor 12 misfirings, shaft 18 rubs, and turbine 14 conditions may be predicted based on the observations captured by the sensor DB 38 or other data.

The physics-based models 80 may include thermodynamic models suitable for predicting future conditions based on starting conditions and physics-based calculations. For example, a starting temperature for turbomachinery 10 components may be input, and a temperature at time t may be derived. Likewise, pressure, flow rates, fuel utilization, material deformations, material stress, and the like, may be derived. The thermodynamic models may include a low cycle fatigue (LCF) life prediction model, a computational fluid dynamics (CFD) model, a finite element analysis (FEA) model, a parametric solid model, a non-parametric solid model, a 3-dimension to 2-dimension FEA mapping model, or a combination thereof. The future predicted modes 83 (e.g., startup mode of operation, shutdown mode of operation.

The visual inspection system 82 may include enhanced borescope inspections (EBI), borescope inspections (BI), and eyeball inspections useful in observing the turbomachinery 10 and reporting on any issues found. For example, a borescope may be introduced into certain sections and/or components of the turbomachinery 10 (e.g., load 24, intake 22, compressor 20, combustor 12, turbine 14, exhaust 16) and used to observe wear and tear, cracks, lubrication state, state of a finish or coating, parts alignment, clearances, and the like. The visual inspection system 82 may then enable a visual evaluation of the current conditions and capabilities of the turbomachinery 10.

A technical evaluation profile 84 may then be provided by the technical evaluation system 76 that describes the results of the technical analysis and/or technical screening activities. The commercial evaluation profile 74 and the technical evaluation profile 84 may then be provided as input to an acceptance system 86. The acceptance system 86 may enable acceptance activities, such as the comparison of the risks versus the returns of allowing the departure request 44. For example, an economic model 88 may be used to determine ROI by comparing the costs against the benefits associated with the departure request 44. Additionally, a regulatory model 90 may be used to provide for regulatory guidelines, including emissions control limits, industry best practices, and workplace guidelines, useful in providing a regulatory framework. The regulatory framework may then be used as another tool for making acceptance decisions enabled by the acceptance system 86.

The acceptance system 86 may then provide for a maintenance action 92. In one embodiment, if the departure request 44 is accepted, the maintenance action 92 may include maintenance recommendations related to the extension of turbomachinery 10 operations, including, for example, performing certain CBM-I and CBM-O activities at certain recommended intervals, as described in more detail below with respect to FIG. 4. If the departure request 44 is not accepted, then the maintenance action 92 may include originally scheduled maintenance activities. The maintenance action 92 and the technical evaluation profile 84 may then be input into a field execution system 94. The field execution system 94 may then execute or otherwise implement the departure request 44 and maintenance action 92. Additionally, the field execution system 94 may monitor and log the implementation of the departure request 44 and maintenance action 92, to provide for execution, execution tracking, validation, and closure as described above with respect to block 50 and block 60 FIG. 3. By enabling the commercial screening, technical evaluation, acceptance, and execution of the departure request 44, the system 62 may provide for additional operating time and increased operating limits for the turbomachinery 10, while maintaining or improving reliability.

FIG. 4 is a timeline diagram having a time dimension 98 of an embodiment of a usage and maintenance schedule 100. In the depicted embodiment, the turbomachinery 10 shown in FIG. 1 may schedule, for example, a HGPI activity 102 to occur approximately every T1 fired hours, denoted by the element 104. Accordingly, an original schedule time 106 denotes when in time the HGPI activity 102 would normally occur. Likewise, the usage and maintenance schedule 100 includes a CI activity 108 scheduled to occur approximately every T2 fired hours, as denoted by the element 110. In the depicted embodiment, the CI activity 108 is also scheduled to occur at the original schedule time 106. It is to be noted that while the depicted intervals T1 and T2 are shown as fired hours, other intervals may include the number of starts, or a combination of fired hours and number of starts. Likewise, it is to be noted that intervals T1 and T2 need not share the same original schedule time 106. The depicted fired hour intervals T1 and T2 may be the same or different from one another, and may be approximately between 1 week to 4 weeks, 1 month to 1 year, 1 month to 2 years, 1 year to 5 years.

As described above, it may be desirable to extend the operations of the turbomachinery 10 beyond the original schedule 106 time. Accordingly, the depicted embodiment of FIG. 4 depicts the use of CBM-I (element 111) to enable an extended operational interval 112. In CBM-I (element 111), an inspection may be applied that includes CBM techniques. For example, the current status of the system may be observed by using the sensor DB 38 shown in FIG. 1, visual inspections, and the like. The current status may then be compared against a desired status to find deviations in performance. The visual inspections may include inspections performed while the turbomachinery 10 is online or running. Indeed, in one embodiment, the turbomachinery 10 may be providing power during the inspections. By performing maintenance when inspections and/or data call for it rather than driven by a fixed schedule, the CBM-I (element 111) may provide for the extended operational interval 112 while enabling reliable, efficient operations of the turbomachinery 10.

At the end of the extended operational interval 110 (e.g., time 114), the turbomachinery 10 would undergo an overhaul. For example, the overhaul may replace certain components (e.g., turbine 14 caps, turbine 14 liners, piping, valves), while other components may be sent to a service shop for reconditioning. However, some of these turbomachinery 10 components may still provide for reliable operations. It would be more efficient and less costly to continue utilizing some of these components rather overhauling the components (e.g., replacing or shipping the components out for reconditioning). Accordingly, CBM-O 116 activities may be scheduled, following the CBM-I enabled interval 112. In CBM-O 116, the turbomachinery 10 may be thoroughly analyzed, for example, by using technical analysis techniques described above with respect to FIGS. 2 and 3 (e.g., statistical models 78, physics-based models 80, visual inspections 82) to derive an estimate of which parts may actually benefit from replacement or reconditioning. Indeed, significant efficiencies, such as logistic efficiencies, may be gained by applying CBM-O 116 techniques that may apply maintenance only to turbomachinery 10 components observed and/or predicted as having an undesired wear and tear. Accordingly, applying the CBM-O 116 technical analysis techniques may result in an extended usage interval 118. During the extended usage interval 118, turbomachinery 10 components that would have otherwise been replaced or reconditioned may now be reliably utilized. Indeed, significant efficiencies related to keeping the turbomachinery 10 components utilized and not removing or shipping the turbomachinery 10 components may be realized. By providing for an extended interval 118 after CBM-O, longer life usage of the turbomachinery 10, reduced costs, and more efficient maintenance activities may be enabled.

Technical effects of the invention include the ability to improve on the operational life of turbomachinery, such as a gas or steam turbine system, a pump, or a compressor. A process and a system are provided that includes technical analysis as well as commercial analysis of risks associated with continuing operations of the turbomachinery and/or extending certain recommended limits (e.g., fired hours, number of starts) reliably and efficiently. Logistic efficiencies may be realized by enabling continued operations and extending limits with current components. In this way, the components may not have to undergo replacement or reconditioning. Further, costs associated with the replacement or reconditioning may be substantially reduced or eliminated, including “execution factor” costs.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system comprising:
a request initiation system configured to initiate a departure request for a turbomachinery;
a commercial screening system configured to receive the departure request and to derive a commercial evaluation profile based on the departure request;
a technical evaluation system configured to derive a technical evaluation profile based on the departure request, wherein the technical evaluation profile comprises a technical analysis of the turbomachinery; and
a request acceptance system configured to derive a maintenance action based on the commercial evaluation profile and the technical evaluation profile.

2. The system of claim 1, comprising a field execution system configured to track the maintenance action based on the technical evaluation profile.

3. The system of claim 2, wherein the maintenance action comprises a condition based maintenance interval (CBM-I) and the field execution system is configured to collect data to validate the CBM-I.

4. The system of claim 1, wherein the departure request comprises a deviation from a condition based maintenance outage (CBM-O), a deviation from a condition based maintenance interval CBM-I, or a combination thereof.

5. The system of claim 1, wherein the request initiation system is configured to use a current maintenance schedule to initiate the departure request.

6. The system of claim 1, wherein the commercial screening system comprises a cost benefit analysis model, an economic model, or a combination thereof.

7. The system of claim 1, wherein the technical evaluation system comprises a statistical analysis model, a visual inspection model, a physics-based model, or a combination thereof.

8. The system of claim 1, wherein the acceptance system comprises a regulatory model, a contractual model, or a combination thereof.

9. The system of claim 1, wherein the turbomachinery comprises a turbine, a compressor, a pump, or a combination thereof.

10. The system of claim 1, wherein the turbomachinery comprises a turbine driven generator system.

11. A method, comprising:
initiating a maintenance change request for a turbomachinery;
performing a commercial screening based on the maintenance change request;
performing a technical screening if the commercial screening determines that the maintenance change request is commercially feasible;
performing a technical risk assessment if the technical screening determines that the maintenance change request is technically feasible;
providing a technical recommendation;
deriving a maintenance action based on the technical recommendation, and executing the maintenance action if the technical risk assessment determines that a risk of the maintenance change request is acceptable.

12. The method of claim 11, wherein executing the maintenance action comprises extending a maintenance interval and collecting validation data to validate the maintenance interval.

13. The method of claim 11, wherein performing the commercial screening comprises performing a cost based analysis, an economic analysis, or a combination thereof.

14. The method of claim 11, wherein performing the technical screening comprises at least one of visually inspecting the turbomachinery, performing a statistical analysis of the turbomachinery, or performing a physics-based analysis of the turbomachinery.

15. The method of claim 11, wherein performing the technical risk assessment comprises assessing a risk of performance degradation of the turbomachinery.

16. The method of claim 11, wherein deriving the maintenance action comprises analyzing at least one of a regulatory model or a contractual model.

17. A non-transitory machine readable media, comprising:
instructions configured to initiate a maintenance change request relating to turbomachinery;
instructions configured to commercially screen the maintenance change request to produce a commercial report;
instructions configured to technically analyze the maintenance change request to produce a technical report; and
instructions configured to accept the commercial report and the technical report to produce a maintenance action.

18. The non-transitory machine readable media of claim 17, comprising instructions configured to generate a maintenance execution report based on the maintenance action.

19. The non-transitory machine readable media of claim 17, wherein the instructions configured to produce the commercial report comprise instructions configured to produce a cost based analysis, an economic analysis, or a combination thereof.

20. The non-transitory machine readable media of claim 17, wherein the instructions configured to technically analyze the maintenance change comprise instructions configured to apply a physics-based model, a statistical model, or a combination thereof.
